(19) United States
(12) Patent Application Publication
(10) Pub. No.: US 2009/0231828 A1
(43) Pub. Date: Sep. 17, 2009

(54) ENCLOSURE SECURING DEVICE

(76) Inventor: Richard MADORE, San Jose, CA (US)

Correspondence Address: GLENN PATENT GROUP, 3475 EDISON WAY, SUITE L, MENLO PARK, CA, 94025, US

(21) Appl. No.: 12/046,414

(22) Filed: Mar. 11, 2008

(51) Int. Cl. H02B 1/04

(52) U.S. Cl. 361/825

(57) ABSTRACT

A securing device for easily attaching enclosure to a cable strand is disclosed, in particular, a mounting bracket for easily attaching a box containing, for example, a pico-cell/femto-cell radio, to a cable strand. It enables one person to handle the attachment process. The bracket meets the requirements for a cable strand bracket, namely, strong attachment, easy handling by a single operator, and with no loose hardware to fall. The disclosed mounting bracket enables easy, safe and low-cost installation of the pico-cell/femto-cell radio box on a cable strand. Other enclosures can be mounted in like manner to cables, pipes, and the like.

### TECHNICAL FIELD

This invention relates to the field of securing a component to an available support element. In a preferred embodiment, the invention provides one or more brackets for mounting a box to a cable, and more specifically a bracket for the mounting of a pico-cell or femto-cell radio box to a cable strand.

### BACKGROUND

There is a general need for an improved method of securing electronic equipment in field applications. All sorts of apparatus are usefully secured to or near utility poles, in utility tunnels and the like. In particular, a common mode of securing an enclosure for electronic equipment is to suspend it from an available cable in the proximity of where the equipment is to be used. Useful examples include cable line splitters, phone line drops, and any number of line condition monitors or other monitoring devices.

In addition, there is a need to make ever-smaller devices, particularly transceivers, readily available at locations. In particular, the use of pico-cell and femto-cell radios (cellular transceivers, hereinafter referred to as radios) for providing efficient coverage of area in cellular networks is becoming more prevalent. In order to do this, a number of differing ways have been proposed for safely securing the radios in field locations, such as attaching the radios to electric supply poles, cable strands, etc. The difficulty has been in attaching the radios in covered box enclosures to cable strands in a cheap, safe and secure fashion.

FIG. 1 shows a typical prior art attachment fixture 100. It consists of a radio box having a top plate 110 which has some striations 112 between two sets of self-threaded screw holes 115 drilled on the top plate of the radio box. The top plate 110 is part of the radio box that is not shown herein in its entirety. An attachment holder 120 is used as a second piece to secure the radio box to the cable strand. The attachment holder has a curved plate 121, which provides a space for the cable strand (not shown) with two flanges 126 on either side. The curved plate has striations 122 within the curved space for gripping the cable for improved securing and positioning of the radio box when attached to the cable strand. The attachment holder 120 has holes 125 for the two pairs of screws 123 with treads 124. These holes 125 are on the flanges 126 extending on either side of the curved plate. The four screws 123 having threads 127 go through the holes 125 in the flange 126, into the self threaded holes 115 in the top plate 110, and when tightened firmly, attach the radio box to the cable strand.

Multiple problems exist with this type of attachment. The first and foremost is the need for two people to be involved in fixing a box to the strand. One person has to hold in place the box having the top plate 110, with the cable strand being adjacent and between the two sets of self threaded holes 115. The other person has to put the attachment holder 120 over it, align the holes 125 with the holes 115 of the top plate 110, insert the screws 123 and tighten them. In many cases, including but not limited to, bad weather conditions, this is a complex effort and difficult to complete. If some elevation is needed for the installation location, two people need to be on ladders or in a snorkel. The need for two people to complete the attachment task increases the cost of attachment. The second problem is the possibility of loose parts, like screws 123 and attachment holder 120, dropping from the workers' height when securing the box to the strand, which can be tens of feet or more above the ground. This can be dangerous both in creating a risk of major injury to anyone below as well as distracting or dangerous to workers trying to catch or retrieve falling components.

Therefore, what is needed is an apparatus and method to overcome the deficiencies of the prior art by having a bracket that can be attached to both the radio box and the cable strand, without any loose parts, which can fall and create hazardous conditions, and which further allows a single person to handle the attachment process.

### SUMMARY

The invention is directed to a method and apparatus for conveniently mounting and securing an enclosure to a support element. In particular, this is well suited to mounting a pico-/femto-cell radio to a cable strand. A bracket is affixed to an enclosure housing, the bracket including a hook or lip so that the enclosure can be positioned on and suspended from a cable strand or other suitable support element. A movable element can be brought into position to retain the bracket against the support element, generally in close contact with the support element.

In a preferred embodiment, a bracket with a hook is secured to the enclosure of a pico-/femto-cell radio. The bracket includes a curved section forming a hook that will retain the enclosure on a cable strand when simply positioned on and suspended from the cable strand. A moving retainer block, preferably integral to the housing, is brought into position against the cable strand to secure the bracket, and the enclosure, on the cable strand. Optionally, the housing or the block or both can include serrations that will improve contact with and grip on the cable strand. Optionally the block is brought into firm contact with the cable strand so the enclosure is tightly affixed to the cable strand. Further in the preferred embodiment, a threaded screw that positions the moving retainer block includes a channel or other suitable feature so one or more set screws can be positioned against the channel or feature preventing further rotation of the threaded screw, thus locking the retainer block into place.

This device makes it easy for a single installer to position the enclosure on the cable strand, then tighten the moving retainer block in a desired position, and then to lock the threaded screw so the entire enclosure is well secured to the cable strand. In another preferred embodiment the enclosure may contain a second or even more such mounting brackets, which can be similarly positioned and secured.

One particularly useful feature of the present invention is that there are no loose parts—all of the components of the bracket securing mechanism are secured to the enclosure before installation begins. The bracket can be secured to the enclosure, which is readily accomplished with the enclosure on the ground or other readily convenient workspace, which might be a shop workbench.

### DESCRIPTION OF THE FIGURES

FIG. 1 is a prior art attachment fixture for attaching a radio box to a cable strand.

FIG. 2 is a schematic diagram of the disclosed bracket for attaching the radio box to the cable strand.

FIG. 3 is an exploded diagram showing the pieces of the disclosed bracket.

FIG. 4 is a figure showing the cable box attached to a cable strand In accordance with the principles of the disclosed invention

### DETAILED DESCRIPTION

This invention is directed to a convenient securing device for connecting an enclosure to a support element, which may preferably be a cable strand or the like. This invention is particularly useful for cellular transceiver equipment but is generally useful for other enclosures or equipment that can be hung from cable strands or poles and the like. It is useful for installation on or near a utility pole, in utility tunnels, in homes or office buildings, or in other applications that will be readily apparent to a user.

In one preferred embodiment, a mounting bracket is provided for easily attaching a box containing, for example, a pico-cell/femto-cell radio, to a cable strand. The simple design and connection process facilitates installation by one person. The bracket is particularly useful for a cable strand bracket, namely, strong attachment, easy handling by a single operator, and with no loose hardware to fall. The disclosed mounting bracket enables easy, safe, and low-cost installation of the pico-cell/femto-cell radio box on the cable strand.

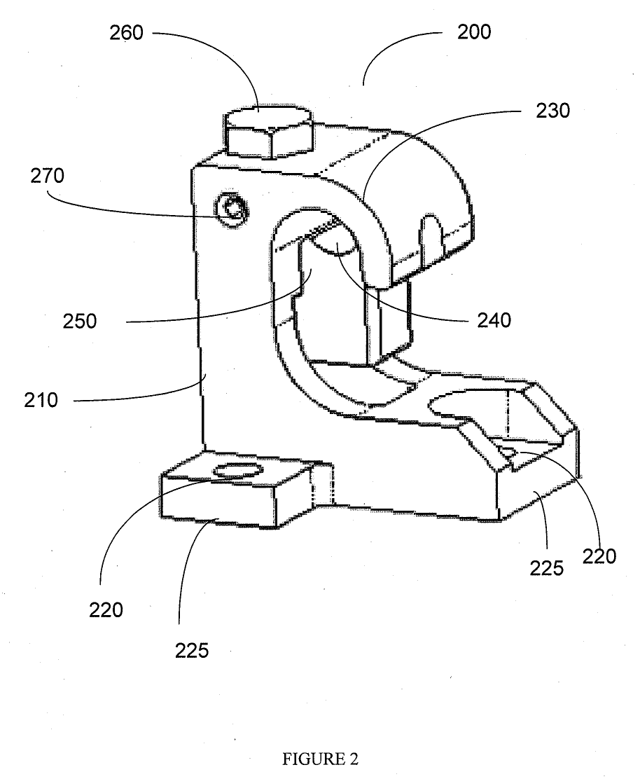

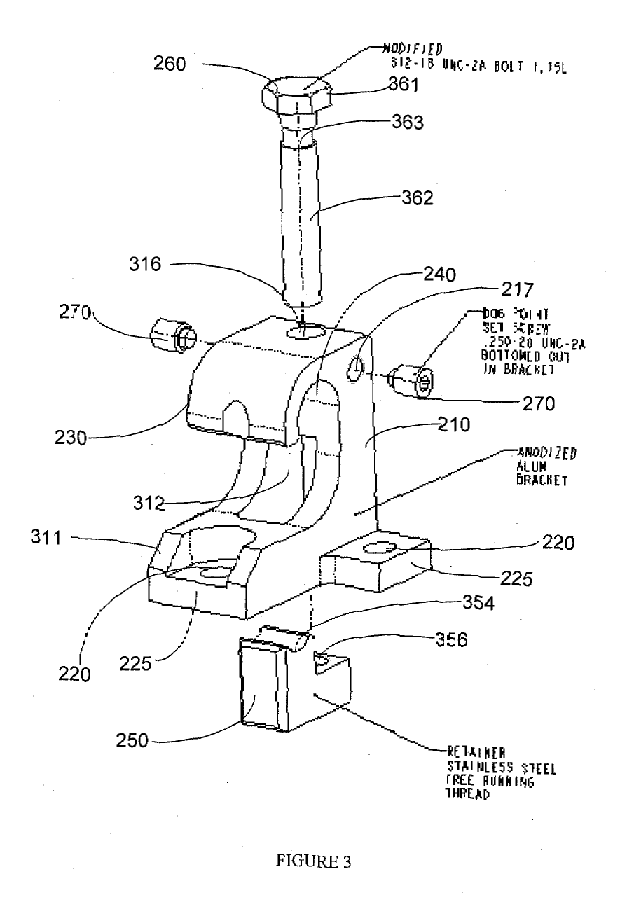

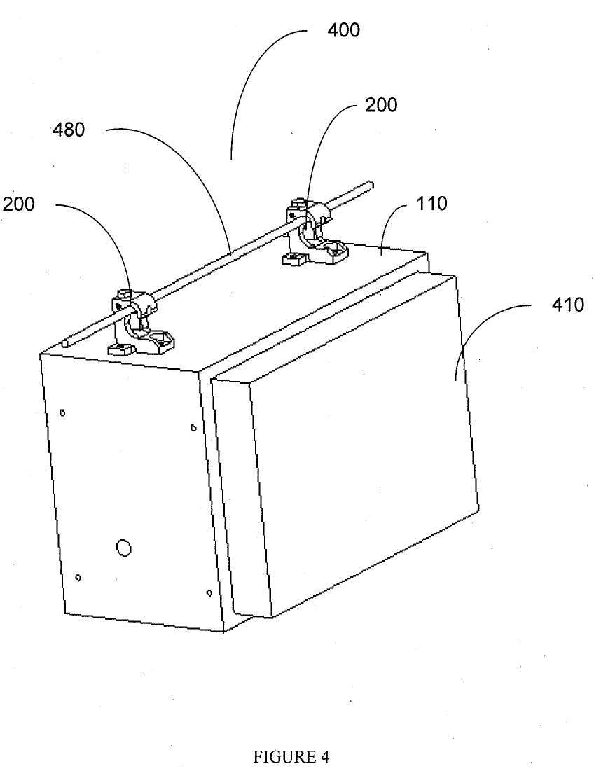

FIG. 2 shows the disclosed bracket 200 for attaching a radio box to a cable strand and FIG. 3 shows an exploded view of the bracket 200. FIG. 4 is the final installation 400 of a radio box 410 attached to a cable strand 480 using the brackets 200. The brackets 200 are attached to the top plate 110 of the radio box 410 by means of screws or bolts. This is done in advance of the mounting process that takes place on the cable strand. The bracket consists of a main bracket body 210 that can be attached to the top plate 110 of the radio box using a plurality of screws/bolts passing through screw holes 220 in flange 225 of the main bracket body 210. These screws can be used to attach the bracket 200 to the top plate 110 of the radio box 410, typically by tightening into threaded holes in the top plate 110 of the radio box 410.

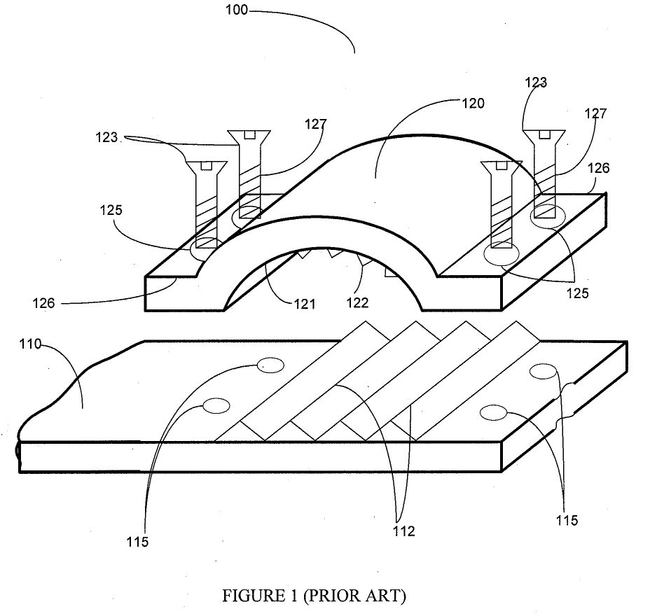

The main bracket body 210 has a curved section 230 on top, which forms a hook with a space 240 under it for the cable strand to pass through. The cable strand is secured by moving retainer block 250 using a threaded screw 260. The threaded portion 362 of the screw 260 passes through a threaded hole 356 with free running thread in the retainer block 250. This retainer block 250 is free to slide up and down a channel 312 in the main bracket body 210 to the length of the thread 362 of the screw 260. The threaded screw 260, used for moving the retainer block 250, is free moving in a vertical aligning hole 316 that passes through the top of the main bracket body 210. The screw 260 can be fixed in place in the assembled bracket by a pair of dog point set screws 270, inserted into threaded holes 217 in the main bracket body 210 from the side. These can be tightened until they engage a predefined grove 363 on the shaft of the screw 260, thereby limiting the vertical or rotational movement of the screw 260 within the hole 316. By rotating the head 361 of the screw 260 in one direction the retainer block 250 can be moved up to tighten the bracket to the cable strand, and by rotating the head 361 of the screw 260 in the other direction the retainer block 250 can be moved down to loosen, the hold of the bracket 200 on the cable strand 480. It is convenient and preferred to move the retainer block down sufficiently to allow insertion of the cable strand 480 into the space 240 within the hook formed by the curved section without disassembling the bracket 200 from the top plate of the radio box 410. Once the retainer block 250 is moved up using screw 260 and the bracket 200 is firmly attached onto the cable strand 480, the two dog point set screws 270 can be tightened further to lock the screw 260 and prevent any movement of the screw 260. This will prevent the radio box 410 from becoming loose due to any kind of movement of the cable strand 480. Even though not shown, in a typical case the inside surface of the curved portion 230 of the main bracket body 210 as well as the surface 354 of the sliding retainer are striated for providing better grip on the cable (see striations 112 in FIG. 1 for comparison).

For most applications at least two brackets 200 are attached to the radio box 410 as shown in FIG. 4. These brackets 200 can be attached to the top plate 210 of the radio box 410 before moving it into position near or on the cable strand 480. The sliding retainer blocks of the brackets 250 are loosened sufficiently, which may be to the maximum, enabling the open jaw of space 240 to be sufficiently large to allow access for the cable strand 480 to pass from the side, below the lip of the curved portion of the main bracket body 210, and into curved section 230. This radio box 410, with two or more brackets 200 attached, is now hung from the cable strand 480 using the hook formed by the curved portion 230 of the main bracket body 210. This hanging of the radio box 410 from the cable strand 480 can be easily done by one person. With the cable strand near or within curved section 230, the screw 260 of the brackets 200 are turned to bring up the retainer block 250 and reduce the space 240 by firmly tightening the bracket 200 around the cable strand 480. The dog point set screws 270 are made tight to stop the rotation of the screw 260 and lock the radio box 410 in place, attached to the cable strand 410.

Since all the pieces of the bracket 200 are secured or enclosed during the fixing of the top plate 110 of the radio box 410 to the cable strand 480, there are no pieces to fall off and cause accidents during the process of attaching the radio box 410 to the cable strand 480. This will reduce the frequency of accidents and resulting liability of the installer, thus providing associated cost reduction. Furthermore, the bracket 200 structure enables its installment by a single person. This invention hence provides for a safe and low-cost alternative mounting apparatus and method thereof using the disclosed mounting bracket. It provides the demonstrated advantages when compared to the prior art methods and apparatus used for attaching radio boxes to cable strands.

This invention encompasses a number of variations on the preferred embodiment described above. The mounting bracket can be secured to the enclosure body in a number of ways, using screws as described here or otherwise (screwed from the reverse side of the top, for example), or by welding, gluing, mating with matching slots, or even formed integrally with the enclosure body. Securing can be by tongue and groove, where one component, for example a groove, is secured to (and perhaps cast into) the enclosure body part, then a matching component, here a tongue, is part of the mounting bracket, and is fitted into the groove. In some instances, a simple screw would be used to secure the mounting bracket and retain the tongue in the groove. The enclosure may be the pico/femto-cell device as described here, or may be any type of device that is to be positioned on and optionally secured to a support element such as a cable strand, pipe, shaft, beam, or other component, particularly one that is inconvenient to thread or pass through some attachment mechanism. Pipes as used in theatrical lighting, or frames such as are common in theater or lighting applications are another example. A separate fixed mounting bracket may be attached to a wall, pole or other support, then the mounting bracket connected to the enclosure is brought into contact with the fixed mounting bracket and then secured according to the teachings of this invention. Other useful applications include securing lighting devices such as are used for theatrical lighting or speakers such as for public address systems. Preferably the enclosure can be suspended from a selected support element, with space to hang by gravity and swing at least slightly, so the enclosure can be hung form the support element by means of the mounting bracket, then secured in position on the support element according to the teachings of this invention. Another useful embodiment of the invention is to mount such an enclosure at an angle that does not permit hanging from the support element, for example in securing the enclosure to a vertical pipe or post. A single installer can still manage the installation by themselves by stabilizing the enclosure and mounting bracket against the support element then actuating the securing apparatus.

The securing apparatus is described here as a hook with a moveable jaw, but the securing apparatus can include a variety of elements. The securing apparatus can take the form of a simple hook, a “C” shape, an inverted “U”, an inverted “V”, a simple lip, an angled component that will stabilize the enclosure when placed on and suspended from the support element, and other shapes that are readily chosen by one skilled in the art.

In a preferred embodiment, at least one bracket element is attached to the enclosure and another element can move in relation to the bracket element attached to the enclosure to position the fixed bracket element as securely as desired to the support element. The central point of the invention is that a first securing element can be placed over the support element (cable strand or pipe or the like), permitting the enclosure to hang without significant further intervention by the installer, freeing the installer to actuate a moveable component to secure the bracket, and therefore the enclosure, to the support element. Some movable portion of the apparatus is positioned to apply pressure on the support element, thus stabilizing and securing the enclosure.

The mounting bracket is conveniently positioned relative to the center of gravity of the enclosure (in more or less the operating configuration) so that when the enclosure is suspended on the support element by the mounting bracket, the enclosure will hang at a useful angle, preferably one that will stabilize the position of the enclosure relative to the mounting bracket and the support element so that the enclosure hangs at a stable angle. For example, mounting the bracket far away from the center of gravity (CG) with the opening facing away from the CG would tend to be ineffective as a line through the support to the CG would pass through the body of the bracket (the opening would be on the opposite side, and thus not between the support element and the CG) and the enclosure would tend to fall. The opposite orientation would be particularly helpful, where when positioned on the support element a line from the body of the bracket to the CG would pass through the support element (for example, a “C” shape with the opening towards the CG and above the support element), thus conveniently suspending the enclosure from the support element.

Positioning two mounting brackets can conveniently include having openings in the brackets facing more or less the same direction, as illustrated in FIG. 4. An installer would lift such an enclosure into position near a support element and approach the support element from the side so the openings in the brackets engage the support element. In an alternative embodiment, one of the brackets is reversed so that the opening is in the opposite direction (not shown) so that the enclosure is brought into position on the support element by rotating the enclosure into position with the openings crossing the support element. This provides a particularly stable position. This orientation is enhanced when the brackets are mounted so the support element will be centered above the center of gravity of the enclosure.

Even though the use of the disclosed mounting bracket is for applications of mounting a radio box to a cable strand, it should not be considered a limitation to the use of the bracket disclosed. The use of the bracket for other applications, where units have to be attached to wires and strands, will become apparent to system implementers in alternate areas and such are included and covered as part of this disclosure.

The foregoing descriptions of embodiments of the invention have been presented for purposes of illustration and description only. They are not intended to be exhaustive or to limit the invention to the forms disclosed. Accordingly, the above disclosure is not intended to limit the invention; the scope of the invention is defined by the appended claims.

The foregoing description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A mounting bracket for supporting an enclosure, said mounting bracket comprising:
support element connecting means connected to the enclosure, and engageable support element securing means;
whereby the enclosure can be retained on the support element by the connecting means without engaging the engageable support element securing means; and
whereby the support element securing means can be engaged with the support element by a single installer.

2. The mounting bracket of claim 1 wherein the enclosure is any of: a package: a device, a box, a cell phone support, a radio, a pico-cell radio, a femto-cell radio, and a micro-cell transmitter transceiver.

3. The mounting bracket of claim 1 wherein the securing is by means of any of screws, welding, retaining slots, tongue and groove, or by integrated formation of the mounting bracket with the enclosure.

4. The mounting bracket of claim 1, wherein the connecting means is any of a hook, lip, angle, inverted U, inverted V, or extended U.

5. The mounting bracket of claim 1, wherein the support element is any of a cable, cable support element, pipe, shaft, beam, or mounting bracket.

6. The mounting bracket of claim 1, wherein the connecting means is further to be stabilized by gravity acting on the enclosure to stabilize the mounting bracket against the support element.

7. To the mounting bracket of claim one wherein the support element connecting means is stabilized by applying pressure to maintain the support element connecting means in a good connection with the support element.

8. The mounting bracket of claim 1 further comprising a second mounting bracket, where the first and second mounting brackets are affixed to the enclosure such that an opening in the first mounting bracket and an opening in the second mounting bracket face in opposite directions so as to connect to the support element from opposite sides.

9. The mounting bracket of claim 1, further comprising an opposing element that can be moved to a secure the mounting bracket to the support element.

10. The mounting bracket of claim 9, wherein the mounting bracket and the opposing movable element, essentially surround the support element.

11. A bracket for attaching a box to a cable strand comprising:
a main bracket body attached to a top plate of the box, said main bracket body having a curved section on top which forms a hook with a space for the cable strand to be positioned under it;
a moving retainer block, said main bracket body having a channel for said retainer block to move in; and
a threaded screw attached to said main bracket body and said retainer block enabling the controlled motion of said retainer block within the limits of said channel;
such that by tightening said threaded screw said retaining block can be moved so as to compress the cable strand against said curved section of said main bracket body thereby attaching the box to the cable strand.

12. The bracket of claim 11, wherein said threaded screw is a free running screw that is fixed in place by two dog point set screws tightened to engage into a horizontal grove on the shaft of the threaded screw.

13. The bracket in claim 11, wherein said hook allows the box to be hung from the cable strand while the retainer block is moved so as to tighten the box to the cable strand.

14. The bracket in claim 11, wherein said hook enables one person to hang the box on the cable strand and handle the attachment of the box to the cable strand.

15. The box of claim 11, wherein said box is one of: a pico-cell radio box; or a femto-cell radio box.

16. A method of securing an enclosure to a support element, said method comprising:
providing an enclosure with a connected mounting bracket, said mounting bracket configured to mate with a support element to facilitate securing said enclosure to said support element;
providing securing means connected to said enclosure and mounting bracket combination;
activating said securing means to secure said enclosure and mounting bracket combination to said support element.

17. The method of claim 16 wherein said support element is a support element.

18. The method of claim 16 where said enclosure is any of: a package: a device, a box, a cell phone support, a radio, a pico-cell radio, a femto-cell radio, and a micro-cell transmitter transceiver.

19. The method of claim 16 wherein said mounting and securing is performed by a single operator.

20. A method for attaching a box to a cable strand by means of a bracket, the bracket comprising a main bracket body attached to a top plate of the box, said main bracket body having a curved section on top which form a hook with a space for the cable strand to be positioned under it; a moving retainer block, said main bracket body having a channel for said retainer block to move in; and a threaded screw attached to said main bracket body and said retainer block enabling the controlled motion of said retainer block within the limits of said channel; the method comprising the steps of:
hooking the bracket portion of the box onto the cable strand; and
causing the retainer block to move towards the cable strand by means of the threaded screw.

21. The method of claim 20, wherein said box is one of: a pico-cell radio box; or a femto-cell radio box.

22. The method of claim 20 further comprising using a single person to hook the bracket portion of the box onto the cable strand and to cause the retainer block to move towards the cable strand by rotating the threaded screw.
